(19) United States
(12) Patent Application Publication
(10) Pub. No.: US 2024/0370958 A1
(43) Pub. Date: Nov. 7, 2024

(54) PREFERRED LEARNING STYLE APPLICATION

(71) Applicant: Felicia McGhee, Raleigh, NC (US)

(72) Inventor: Felicia McGhee, Raleigh, NC (US)

(21) Appl. No.: 18/649,041

(22) Filed: Apr. 29, 2024

Related U.S. Application Data
(60) Provisional application No. 63/499,330, filed on May 1, 2023.

(51) Int. Cl. G06Q 50/20

(52) U.S. Cl. CPC G06Q 50/20

(57) ABSTRACT

A computer-implemented method is designed to personalize educational content to a user's unique learning style utilizing personalized feedback using an algorithm that creates a learning pathway for each user. The algorithm utilizes information such as a user's preferred learning style, previous answers, and time spent on questions and lessons to adjust the user's learning pathway and to provide real-time feedback to the user.

### CROSS-REFERENCE TO RELATED APPLICATIONS

This application claims the benefit of U.S. Provisional Application No. 63/499,330, filed on May 1, 2023, which is hereby incorporated by reference in its entirety.

### FIELD OF THE INVENTION

The present invention is directed to an application that creates a personalized learning profile for each respective user based on the user's preferred learning style. More particularly, this invention relates to an application that utilizes an algorithm to create and adjust lesson materials for the user based on the user's interactions with the application and the user's learning style.

### BACKGROUND OF THE INVENTION

The following description is not an admission that any of the information provided herein is prior art or relevant to the present invention, or that any publication specifically or implicitly referenced is prior art. Any publications cited in this description are incorporated by reference herein. Where a definition or use of a term in an incorporated reference is inconsistent or contrary to the definition of that term provided herein, the definition of that term provided herein applies and the definition of that term in the reference does not apply.

This learning style application aims to create educational equity by challenging standardized tests with individualized tests. Enhancing user engagement is emerging as a prime concern in education. Additionally, the educator “burnout” as it is coined has been rampant as the educators attempt to foster creative methods to best tailor education to many users simultaneously all of whom have different learning styles in order to meet respective school districts' pacing benchmarks such as initiatives that encourage active learning and development of critical readiness skills in the users.

### SUMMARY OF THE INVENTION

The application objective is to create a personal profile of each user's learning ability and then individualize instructions to the learner's optimal learning style. This changes as the user progresses in that assignment/instruction, creating maximal education, less misunderstanding, and equity for all learners. The application presented will be utilized to create a personal profile of each student's learning ability and will then individualize lessons, which can change as the student progresses in that assignment. The language changes and the difficulty of respective levels will allow students to learn at their own pace, and will allow students' instructors to guide students through the application. This application enables the student to review lessons as needed and the ability to advance to higher grade levels than their “base level” as the student's knowledge of the material progresses. The application must have the core instructions, and the application must be adaptive.

A computer-implemented method tangibly embodied in a non-transitory machine-readable storage medium, the computer-implemented method comprises the steps of receiving, by one or more peripherals, a user input, the user input indicating a user's preferred learning style, wherein the learning style is a predefined learning style; importing information for a question or a lesson from a connected educational database; importing information for the user from a connected user database; generating a new question through artificial intelligence platform based on the user's preferred learning style, the information from the connected user database, and the connected educational database; displaying the new question to the user; receiving, by one or more peripherals, a user's answer to the new question; exporting the user's answer to the connected user database and the artificial intelligence platform; importing information from the connected user database to the artificial intelligence platform; generating feedback on the user's answer to the new question from the artificial intelligence platform based on the imported information from the connected user database; and exporting the feedback from the artificial intelligence platform to the user database.

In one embodiment, the connected user database exports information from an initial assessment about a user's current understanding of a subject.

In yet another embodiment, the artificial intelligence platform further comprises utilizing a rule-based system to categorize the user's learning style based on predefined rules and the predefined learning styles.

In a further embodiment, the artificial intelligence platform comprises utilizing a generative pre-trained transformer to generate the new question and the feedback.

In an embodiment, computer-implemented method further comprises the steps of displaying to the user an assessment of a subject; receiving, from one or more peripherals, user answers to the assessment; and exporting the user answers to the assessment to the user database and the generative pre-trained transformer, wherein the generative pre-trained transformer generates a personalized learning path for the user.

In yet another embodiment, the generative pre-trained transformer comprises the step of adjusting the personalized learning path for the user based on the generated feedback and the user's preferred learning style.

In still another embodiment, the feedback is provided to the user in real-time.

In a further embodiment, the information from the user database comprises the user's previously selected learning style, the feedback generated from previous questions/lessons, and time spent on lessons/quizzes.

In yet another embodiment, the computer-implemented method displays game elements such as points, levels, badges, and leaderboards.

In one embodiment, the predefined learning styles comprise visual, auditory, reading, and kinesthetic learning styles.

In another embodiment, the connected educational database and the connected user database are operatively connected to the computer-implemented method via a cloud-based service.

### BRIEF DESCRIPTION OF THE DRAWINGS

FIG. 1 illustrates an example startup screen for the present invention.

FIG. 2 illustrates an example account creation screen for the present invention.

FIG. 3A illustrates an example login screen for a user to sign in using a username.

FIG. 3B illustrates an example login screen for a user to sign in using a school identification number.

FIG. 4 illustrates an example of a lesson screen that displays options of different learning styles for a user to choose from.

FIG. 5 illustrates an example of a lesson screen displaying a lesson using an auditory learning style in the form of a video lecture.

FIG. 6 is a flowchart illustrating steps of the application transforming a question based on a user's selected learning style.

### DETAILED DESCRIPTION

As used in the description herein and throughout the claims that follow, the meaning of “a,” “an,” and “the” includes plural reference unless the context clearly dictates otherwise. Also, as used in the description herein, the meaning of “in” includes “into” and “on” unless the context clearly dictates otherwise.

As used herein, the term “computer-implemented method” is synonymous with the term “application” unless the context clearly dictates otherwise.

As used herein, the term “about” in conjunction with a numeral refers to a range of that numeral starting from 10% below the absolute of the numeral to 10% above the absolute of the numeral, inclusive.

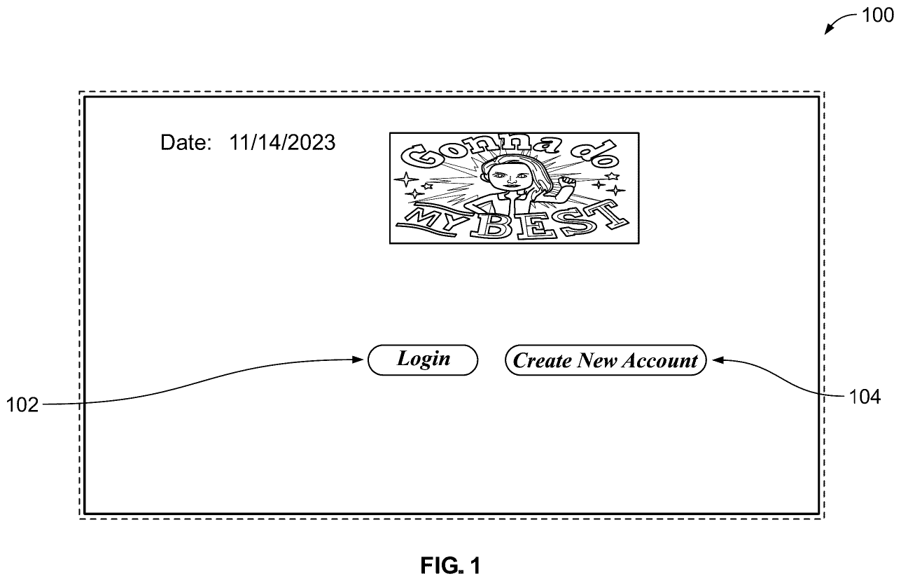

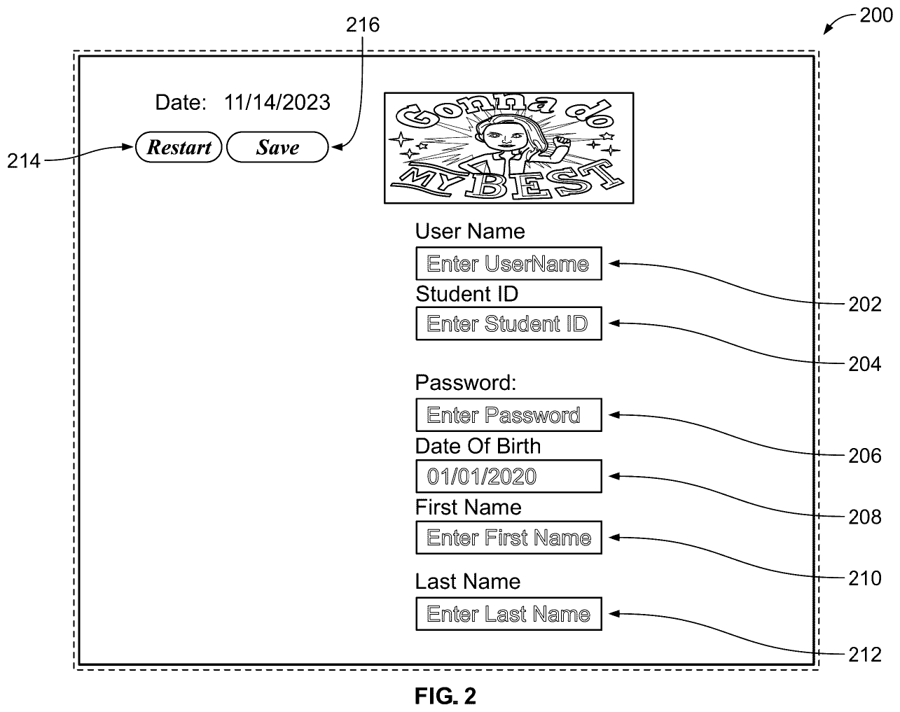

FIG. 1 depicts an exemplary configuration of startup screen 100 for an application. A user can create a new account by selecting new account button 104. By selecting new account button 104 the user will transition to new account screen 200 as depicted in FIG. 2.

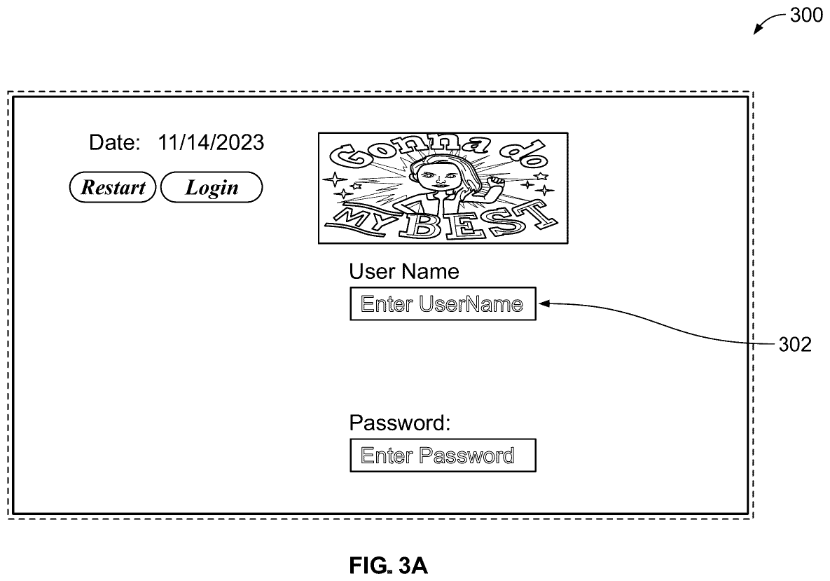

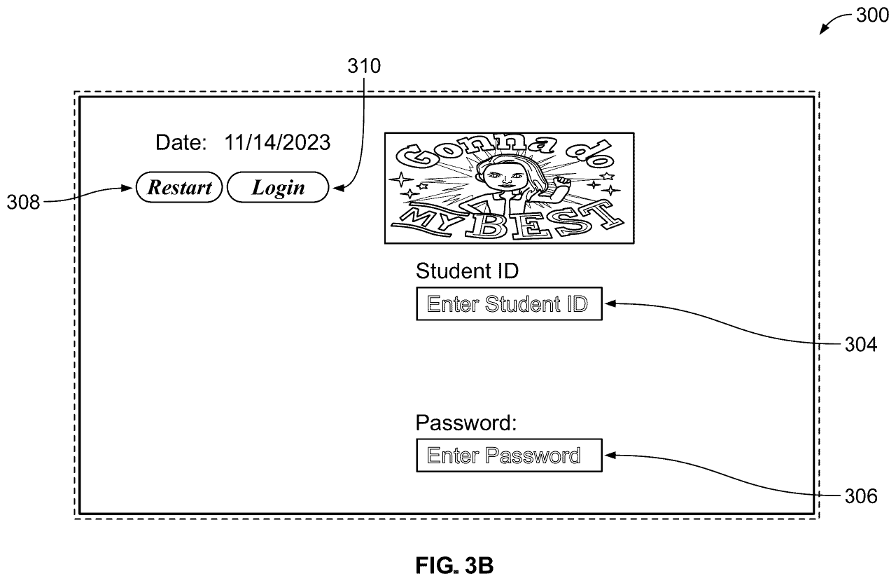

Alternatively, if the user already has an account, the user can select login button 102 to transition to login screen 300 as depicted in FIGS. 3A and 3B.

FIG. 2 depicts an embodiment of new account screen 200 along with several fields for a user creating a new account. In the present embodiment, new account screen 200 displays the fields: username field 202, student identification field 204, password field 206, birthdate field 208, first name field 210, and last name field 212. Additionally, new account screen 200 displays restart button 214 and save button 216. A user can input information username field 202, student identification field 204, password field 206, birthdate field 208, first name field 210, and last name field 212 to fill out information to create an account. The application can receive user input from several peripherals including, but not limited to, a computer mouse, keyboard, or stylus. In the present embodiment, the application receives user input from a computer mouse and keyboard. In some embodiments, several fields on new account screen 200 would be optional for a user to fill out. In the present embodiment, has an option to fill out username field 202 or student identification field 204. Restart button 214 allows the user to clear any entries in the fields on new account screen 200 and return to startup screen 100 (FIG. 1). After the user fills out the information on new account screen 200, the user can select save button 216 to save the account to an external database of accounts.

FIG. 3A depicts one embodiment of login screen 300 along with several fields for signing into the application. In the present embodiment, login screen 300 displays the fields username field 302 and password field 306. A user can input information into username field 302 and password field 306 to fill out the login information for the application. Similarly, FIG. 3B depicts one embodiment of login screen 300 with student identification field 304 and password field 306. A user can input information into student identification field 304 and password field 306 to fill out the login information for the application. Additionally, login screen 300 displays restart button 308 and login button 310. Restart button 308 allows the user to clear any entries in the fields on login screen 300 and return to startup screen 100 (FIG. 1). After the user fills out the information on login screen 300, a user can sign into the application by selecting login button 310.

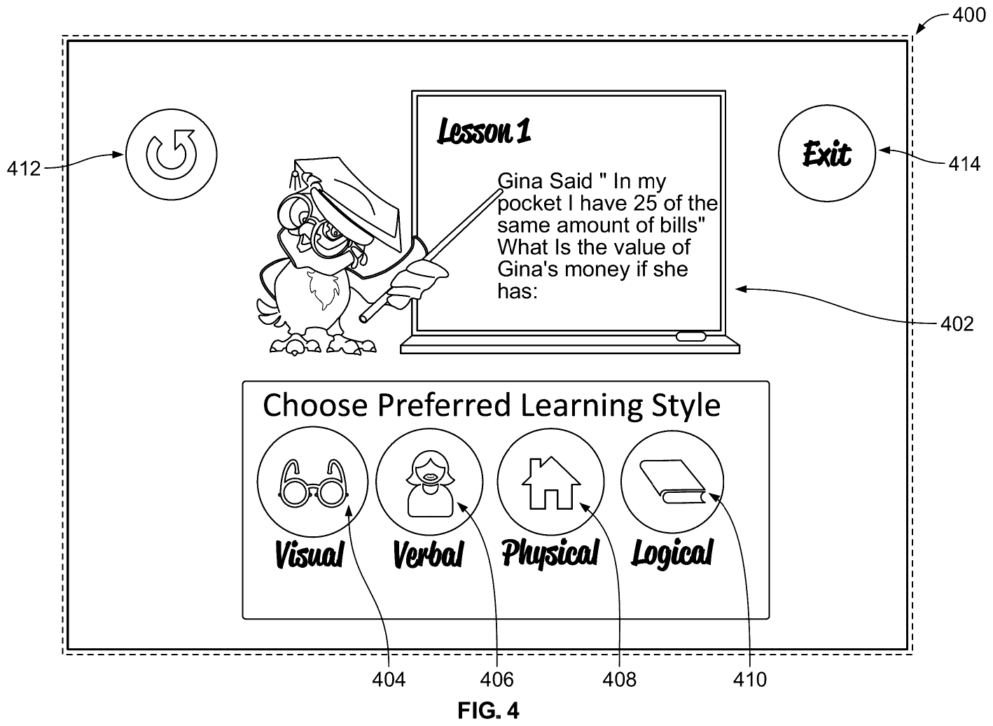

FIG. 4 depicts an exemplary embodiment of lesson screen 400 with a question inside question box 402 to solve. At the bottom of lesson screen 400, there are buttons labeled with a respective learning style. In the present embodiment, lesson screen 400 displays four buttons: visual learning style button 404, verbal learning style button 406, physical learning style button 408, and logical learning style button 410. Visual learning style button 404, verbal learning style button 406, physical learning style button 408, and logical learning style button 410 represents the Visual, Auditory, Reading, and Kinesthetic (VARK) learning styles, respectively, and VARK-similar learning styles. A user can select a certain learning style using one of the buttons to have the instructions and explanations of a particular lesson transformed to fit their preferred learning style that repurposes the content. A user that prefers a visual learning style can select visual learning style button 404 to have their instructions and explanations transformed from the default style to images, diagrams, or flowcharts. A user that prefers an auditory learning style can select verbal learning style button 406 to have their instructions and explanations transformed from the default style to lectures or podcasts. A user who prefers a kinesthetic learning style can select physical learning style button 408 to have their instructions and explanations transformed from the default style to simulations, virtual labs, or interactive exercises. A user who prefers a reading/writing style can select logical learning style button 410 to keep the instructions in the default style. In some embodiments of the application, a user is given an initial assessment or questionnaire to determine a user's preferred learning style. A user can restart the lesson provided on lesson screen 400 by selecting restart button 412. A user can close the application by selecting exit button 414.

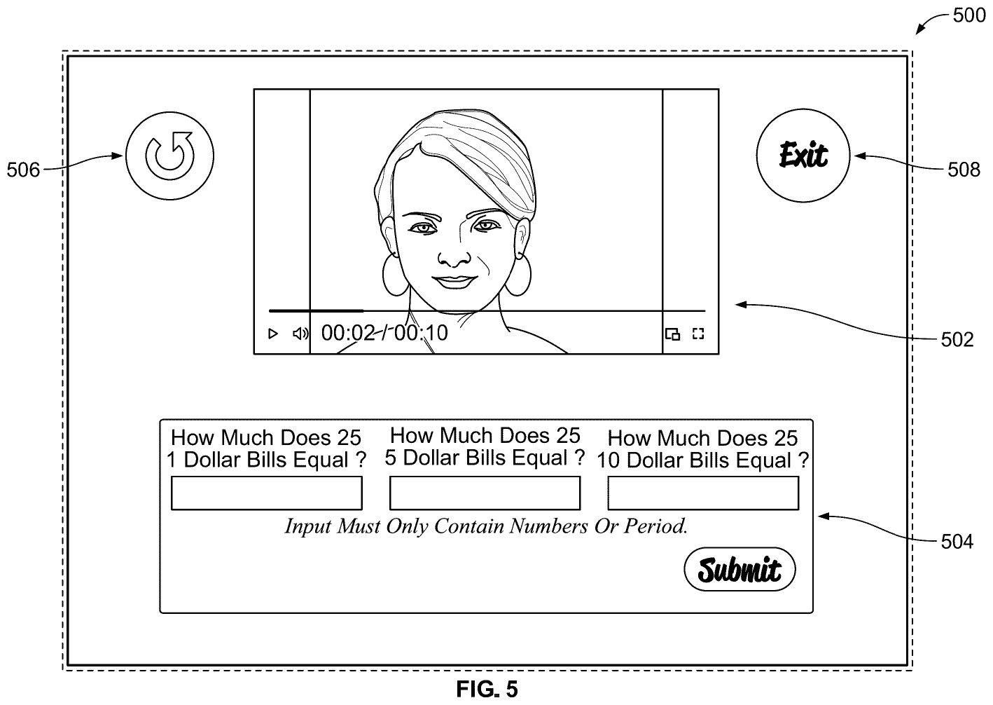

FIG. 5 depicts an exemplary embodiment of lesson screen 400, 500 for an auditory learning style. In the present embodiment, lesson instruction box 502 contains a video lecture for a user to learn the subject. In other embodiments, lesson instruction box 502 may consist of, but is not limited to, podcasts, lectures, images, diagrams, or flowcharts. The application displays a question in question box 504 relating to the lesson provided in lesson instruction 502. A user can restart the lesson provided on lesson screen 500 by selecting restart button 506. A user can close the application by selecting exit button 508.

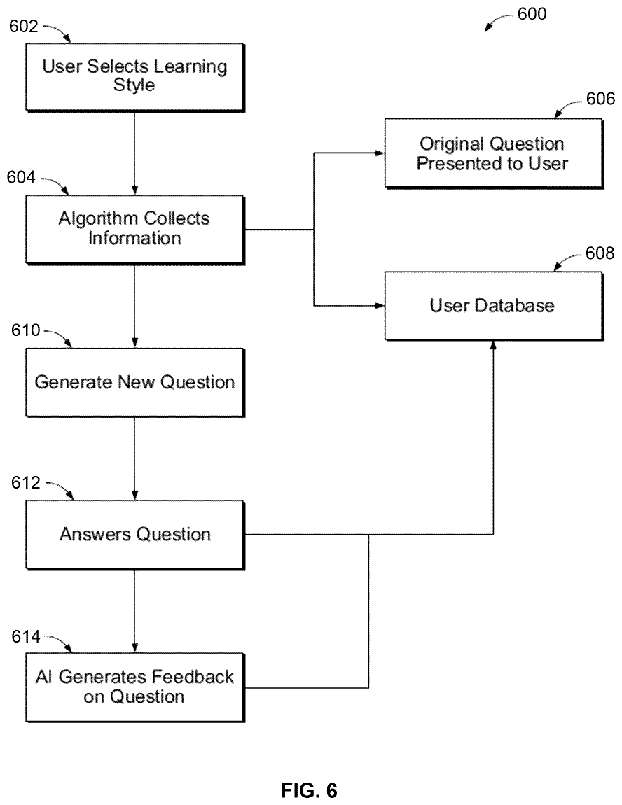

Flowchart 600 illustrates steps that the application's algorithm would follow for creating a personalized lesson/question for a user based on a user's personalized learning path (see FIG. 6). The algorithm utilizes artificial intelligence (AI), such as generative pre-trained transformers (GPTs), to create personalized, adaptive learning paths by assessing a user's knowledge and monitoring their performance and preferences. In some embodiments, the application provides the user with an initial assessment to establish the user's current understanding and skills in a subject. In the present embodiment, the algorithm starts with obtaining the user's preferred learning style in step 602. After obtaining the user's preferred learning style, the algorithm will collect the information based on the user's input in step 604. In addition to receiving user input from several peripherals including, but not limited to, a computer mouse, keyboard, or stylus, the application utilizes computer vision to process information from the input of the user. In the present embodiment, the algorithm will access information about the original question/lesson provided to user from a database in step 606. In some embodiments, the application utilizes cloud-based services to manage lesson data and user data. In the present embodiment, the application utilizes cloud-based services to manage lesson data and user data. Furthermore, the algorithm accesses a database that contains data from each user of the application in step 608. The user database contains information such as, but is not limited to, the user's previously selected learning style, feedback generated from previous questions/lessons, time spent on lessons/quizzes, and user's progress over time. The application uses this information along with AI tools such as GPTs for generating a new question/lesson in step 610 and generating feedback in step 614 using text analysis, summarization, and sentiment analysis. In one embodiment, the algorithm utilizes a text-to-speech system to generate a question for an auditory learning style. The application displays the question produced by step 610 to the user for the user to answer.

After the user answers the question in step 612, the algorithm will send information to the user database shown in step 608 and to an AI platform to generate feedback based on the question in step 614. The information sent to the user database and the AI platform may include, but is not limited to, quiz scores, time spent on content, and how the user interact with different features, such as highlighting specific parts of text, replaying animations, or taking notes via a separate note-taking section that is accessible to the user during lessons. The application utilizes the tracked time spent on content to note indirect signs of confusion, such as frequent pauses, repeated replays of content, or skipping complex material. In step 614, the AI platform will analyze the data from the user answering the question in step 612 and information from the user database in step 608 to identify the user's strengths and weaknesses and dynamically adjusts the learning path accordingly. The AI generated feedback in step 614 analyzes a user's interaction with the application through the user's responses such as to quizzes and tests and provides personalized feedback in real-time, which can include highlighting areas of difficulty or confusion in the user interface, using notifications or color schemes to draw attention to them, suggesting alternative learning resources based on a user's preferred learning style, offering additional explanations, present concepts in different formats such as visual aids for complex topics or break down information into smaller components. In some embodiments, the algorithm will allow the user to revisit topics or explore areas of interest in greater depth based on a user's interactions.

The application trains itself on large datasets and continues to adapt based on collected data from the users' performance on different tasks allows the application to identify patterns and suggest new or improved algorithms. The collected data is analyzed using rule-based systems, which are a type of AI that operates on a set of predefined rules and the application of predefined rules to categorize learning styles based on specific patterns in the data.

The application incorporates game elements through gamification, by blending educational content with game-like features and displaying these elements to the user. In some embodiments, these game elements may include, but is not limited to, using points, levels, badges, and leaderboards to motivate and reward users for their progress and achievements. The application adjusts for VARK or VARK-similar learning styles by altering these game elements according to the user's selected learning style through the user of AI, such as with GPTs. Some examples include, but are not limited to, graphical challenges or quests for visual learners; story-based games or audio puzzles for auditory learners; and interactive, hands-on tasks or simulations for kinesthetic learners.

The application can be accessed outside of a school setting by way of third-party computers and databases. The application can interact with third-party databases primarily through Application Programming Interfaces (APIs), facilitating secure and structured data exchange. APIs enable the application to access and retrieve a wide range of data, such as educational content or user data. Additionally, the application may utilize data import and export functionalities which allow for the batch processing of information for user profiles or educational resources to and from databases, such as for lessons or questions. This process involves using standard data formats such as CSV, XML, or JSON, facilitating the integration of external data into the learning platform.

Thus, specific configurations of a preferred learning style application have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A computer-implemented method tangibly embodied in a non-transitory machine-readable storage medium, the computer-implemented method comprising the steps of:
a. receiving, by one or more peripherals, a user input, said user input indicating a user's preferred learning style, wherein said learning style is a predefined learning style;
b. importing information for a question or a lesson from a connected educational database;
c. importing information for said user from a connected user database;
d. generating a new question through artificial intelligence platform based on said user's preferred learning style, said information from said connected user database, and said connected educational database;
e. displaying said new question to said user;
f. receiving, by one or more peripherals, a user's answer to said new question;
g. exporting said user's answer to said connected user database and said artificial intelligence platform;
h. importing information from said connected user database to said artificial intelligence platform;
i. generating feedback on said user's answer to said new question from said artificial intelligence platform based on said imported information from said connected user database; and
j. exporting said feedback from said artificial intelligence platform to said user database.

2. The computer-implemented method of claim 1, wherein said connected user database exports information from an initial assessment about a user's current understanding of a subject.

3. The computer-implemented method of claim 1, wherein said artificial intelligence platform further comprises utilizing a rule-based system to categorize said user's learning style based on predefined rules and said predefined learning styles.

4. The computer-implemented method of claim 1, wherein said artificial intelligence platform comprises utilizing a generative pre-trained transformer to generate said new question and said feedback.

5. The computer-implemented method of claim 4, wherein said computer-implemented method further comprises the steps of:
a. displaying to said user an assessment of a subject;
b. receiving, from one or more peripherals, user answers to said assessment; and
c. exporting said user answers to said assessment to said user database and said generative pre-trained transformer, wherein said generative pre-trained transformer generates a personalized learning path for said user.

6. The computer-implemented method of claim 5, wherein said generative pre-trained transformer comprises the step of adjusting said personalized learning path for said user based on said generated feedback and said user's preferred learning style.

7. The computer-implemented method of claim 1, wherein said feedback is provided to said user in real-time.

8. The computer-implemented method of claim 1, wherein said information from said user database comprises said user's previously selected learning style, said feedback generated from previous questions/lessons, and time spent on lessons/quizzes.

9. The computer-implemented method of claim 1, wherein said computer-implemented method displays game elements such as points, levels, badges, and leaderboards.

10. The computer-implemented method of claim 1, wherein said predefined learning styles comprise visual, auditory, reading, and kinesthetic learning styles.

11. The computer-implemented method of claim 1, wherein said connected educational database and said connected user database are operatively connected to said computer-implemented method via a cloud-based service.
